(19) United States
(12) Patent Application Publication
(10) Pub. No.: US 2026/0279027 A1
(43) Pub. Date: Sep. 17, 2026

(54) MODEL TRAINING METHOD AND DEFECT DETECTION

(71) Applicant: Tencent Technology (Shenzhen) Company Limited, Shenzhen (CN)

(72) Inventors: Yi ZENG, Shenzhen (CN); Jun LIU, Shenzhen (CN); Chengjie WANG, Shenzhen (CN)

(73) Assignee: Tencent Technology (Shenzhen) Company Limited, Shenzhen, GD (CN)

(21) Appl. No.: 19/667,631

(22) Filed: May 4, 2026

Related U.S. Application Data
(63) Continuation of application No. PCT/CN2025/086114, filed on Mar. 31, 2025.

(30) Foreign Application Priority Data
Apr. 2, 2024 (CN) 202410393625.2

(51) Int. Cl. G06V 10/778; G06V 10/764; G06V 10/77; G06V 10/774; G06V 10/776; G06V 20/50

(52) U.S. Cl. CPC G06V 10/778; G06V 10/764; G06V 10/7715; G06V 10/7747; G06V 10/776; G06V 20/50; G06V 2201/06

(57) ABSTRACT

In a defect detection method, a first training image set, a second training image set, and an initial detection model are acquired. The initial detection model is trained based on the first training image set. The first training image set includes one or more first sample defect images. The second training image set includes one or more second sample defect images. The initial detection model includes a first weight parameter set. The first weight parameter set includes a plurality of first weight parameters. The initial detection model is trained, based on a first sampled image set, the second training image set, and the first weight parameter set, to adjust the plurality of model parameters of the initial detection model so as to obtain an optimized detection model. The first sampled image set includes a subset of the one or more first sample defect images in the first training image set.

### RELATED APPLICATIONS

The present application is a continuation of International Application No. PCT/CN2025/086114, filed on Mar. 31, 2025, which claims priority to Chinese Patent Application No. 202410393625.2, filed on Apr. 2, 2024. The entire disclosures of the prior applications are hereby incorporated by reference.

### FIELD OF THE TECHNOLOGY

This disclosure relates to the field of artificial intelligence technologies, including model training and defect detection.

### BACKGROUND

Industrial quality inspection refers to a process of performing quality inspection and control on products or parts in an industrial production process, and an objective of industrial quality inspection is to ensure that the products meet stipulated quality standards and requirements, to improve a product pass rate and quality stability.

Currently, a defect detection technology based on deep learning can achieve relatively high precision. In an example, a large amount of training data is acquired in advance for model training, and then a trained neural network model is employed to perform defect detection. However, as an industrial quality inspection project proceeds, a volume of data collected for training a deep learning model gradually increases. However, in middle and later stages of the project, the sheer volume of training data leads to long training time and high consumption of computing resources, resulting in a very high cost for each iteration.

In the related example, two technical solutions are employed, for example: performing model iteration by using full training data and performing model fine tuning by using incremental data. However, the two solutions both have some problems. When model iteration is performed by using full data, if a data volume is very large, both computational resources and time cost required for training are very high. When model fine tuning is performed by using the incremental data, as training time is prolonged or the quantity of times of fine tuning increases, the model gradually deviates from original knowledge, leading to catastrophic forgetting of historical data, and further causing a rapid decline in an overall capability of the model and insufficient stability.

### SUMMARY

Aspects of the disclosure provide a model training method, a defect detection method, and related apparatuses. In the model training method, an initial detection model is trained by using a subset of trained historical training data and full newly added training data, to solve the problem in the related example of excessive computational resource consumption and time costs caused by using full training data for model updating, and the problem of catastrophic forgetting caused by using full newly added training data for fine tuning of the model. In the defect detection method, an optimized detection model obtained by using the model training method is employed to detect a defect in a to-be-detected image, thereby improving defect identification effect and accuracy.

According to an aspect of the disclosure, a method of defect detection is provided. In the method, a first training image set, a second training image set, and an initial detection model are acquired. The initial detection model is trained based on the first training image set. The first training image set includes one or more first sample defect images. The second training image set includes one or more second sample defect images. The one or more second sample defect images are different from the one or more first sample defect images. The initial detection model includes a first weight parameter set. The first weight parameter set includes a plurality of first weight parameters of a plurality of first model parameters in the initial detection model. The plurality of first weight parameters indicates importance levels of the plurality of first model parameters in the initial detection model. The initial detection model is trained, based on a first sampled image set, the second training image set, and the first weight parameter set, to adjust the plurality of first model parameters of the initial detection model and to obtain an optimized detection model for defect detection. The first sampled image set includes a subset of the one or more first sample defect images in the first training image set. The optimized detection model is obtained from the training of the initial detection model with adjustment magnitudes of the plurality of first model parameters in the initial detection model that are constrained according to the importance levels that are indicated by the plurality of first weight parameters.

According to another aspect of the disclosure, a defect detection apparatus is provided. The defect detection apparatus includes processing circuitry. The processing circuitry configured to acquire a first training image set, a second training image set, and an initial detection model. The initial detection model is trained based on the first training image set. The first training image set includes one or more first sample defect images. The second training image set includes one or more second sample defect images. The one or more second sample defect images are different from the one or more first sample defect images. The initial detection model includes a first weight parameter set. The first weight parameter set includes a plurality of first weight parameters of a plurality of first model parameters in the initial detection model. The plurality of first weight parameters indicates importance levels of the plurality of first model parameters in the initial detection model. The processing circuitry is configured to train the initial detection model, based on a first sampled image set, the second training image set, and the first weight parameter set, to adjust the plurality of first model parameters of the initial detection model and to obtain an optimized detection model for defect detection. The first sampled image set includes a subset of the one or more first sample defect images in the first training image set. The optimized detection model is obtained from the training of the initial detection model with adjustment magnitudes of the plurality of first model parameters in the initial detection model that are constrained according to the importance levels that are indicated by the plurality of first weight parameters.

According to yet another aspect of the disclosure, a non-transitory computer readable storage medium is provided. The non-transitory computer readable storage medium stores instructions which, when executed by at least one processor, cause the at least one processor to perform any of the described methods for model training and/or defect detection.

In an aspect of the disclosure, a model training method is provided, including: acquiring a first training image set, a second training image set, and an initial detection model, the initial detection model being trained based on the first training image set, the first training image set including a first sample defect image, the second training image set including a second sample defect image, the second sample defect image being different from the first sample defect image, the initial detection model including a first weight parameter set, the first weight parameter set including a first weight parameter of a plurality of model parameters in the initial detection model, and the first weight parameter being configured for representing importance of a plurality of model parameters of the initial detection model; and training the initial detection model based on a first sampled image set, the second training image set, and the first weight parameter, to adjust the plurality of model parameters of the initial detection model, to obtain a trained optimized detection model, the first sampled image set including a portion of sample defect images in the first training image set, and the first weight parameter set being configured for constraining an adjustment magnitude of the model parameters in the initial detection model.

In another aspect of the disclosure, a model training apparatus is provided, including: a training image and initial model acquisition module, and a model training module.

The training image and initial model acquisition module is configured to acquire a first training image set, a second training image set, and an initial detection model. The initial detection model is trained based on the first training image set. The first training image set includes a first sample defect image. The second training image set includes a second sample defect image. The second sample defect image is different from the first sample defect image. The initial detection model includes a first weight parameter set. The first weight parameter set includes a first weight parameter of a plurality of model parameters in the initial detection model, and the first weight parameter is configured for representing importance of the model parameters of the initial detection model; and

The model training module is configured to train the initial detection model based on a first sampled image set, the second training image set, and the first weight parameter, to adjust the plurality of model parameters of the initial detection model, to obtain a trained optimized detection model. The first sampled image set includes a portion of sample defect images in the first training image set, and the first weight parameter set is configured for constraining an adjustment magnitude of the model parameters in the initial detection model.

In another aspect of the disclosure, a defect detection method is provided, including: acquiring a to-be-detected image; inputting the to-be-detected image into an optimized detection model, the optimized detection model including a feature extraction network and a classification network, and the optimized detection model being obtained by using any one of the foregoing model training methods; performing feature extraction on the to-be-detected image based on the feature extraction network in the optimized detection model, to obtain a to-be-detected image feature; and performing defect classification on the to-be-detected image feature based on the classification network, to obtain predicted defect information of the to-be-detected image, the predicted defect information being configured for representing a classification result of whether the to-be-detected image includes a defect.

In another aspect of the disclosure, a defect detection apparatus is provided, including: a to-be-detected image acquisition module, configured to acquire a to-be-detected image; a to-be-detected image input module, configured to input the to-be-detected image into an optimized detection model, the optimized detection model including a feature extraction network and a classification network, and the optimized detection model being obtained by using any one of the foregoing model training methods; a to-be-detected image feature extraction module, configured to perform feature extraction on the to-be-detected image based on the feature extraction network in the optimized detection model, to obtain a to-be-detected image feature; and a to-be-detected image feature classification module, configured to perform defect classification on the to-be-detected image feature based on the classification network, to obtain predicted defect information of the to-be-detected image, the predicted defect information being configured for representing a classification result of whether the to-be-detected image includes a defect.

In further another aspect, embodiments of the disclosure provide a computer device, including: a processor, a communication interface, a memory, and a communications bus, where the processor, the communication interface, and the memory are communicated with each other through the communications bus, and the communication interface is an interface of a communication module; and the memory is configured to store a computer program and transmit the computer program to the processor; and the processor is configured to invoke the computer program in the memory to perform the methods in the foregoing aspects.

In yet another aspect, embodiments of the disclosure provide a storage medium, the storage medium having a computer program stored therein, and the computer program being configured for performing the methods in the foregoing aspects.

In yet another aspect, embodiments of the disclosure provide a computer program product including a computer program, the computer program product, when run on a computer, causing the computer to perform the methods in the foregoing aspects.

It can be seen from the foregoing technical solutions that the aspects of the disclosure have advantages as follows:

The disclosure provides the model training method and the related apparatus. In the model training method, the initial detection model is trained by using the subset of the trained historical training data (the first sampled image set) and full newly added training data (the second training image set), which saves more time and reduces graphics processing unit (GPU) computational consumption compared to training the initial detection model by using the full historical training data and the full newly added training data. By using the first weight parameter set that adaptively evaluates the importance of the model parameters, an updating magnitude of some important model parameters is constrained by using the training data during a training stage. Since these important model parameters are critical for accurately identifying defects involved in the first training image set, an adjustment range of these model parameters is relatively constrained based on accurate indication of the first weight parameter set. Thus, a problem of catastrophic forgetting caused by fine tuning the model by using only full newly added training data is solved, a learning capability of the detection model is improved, and defect identification effect and accuracy of the detection model are improved.

The disclosure further provides the defect detection method and the related apparatus. The optimized detection model obtained by using the model training method is employed to detect the defect in the to-be-detected image to obtain the classification result of whether the to-be-detected image includes the defect, thereby improving the defect identification effect and accuracy.

### BRIEF DESCRIPTION OF THE DRAWINGS

FIG. 1 is a schematic architectural diagram of a model training system according to an aspect of the disclosure.

FIG. 2 is a flowchart of a model training method according to an aspect of the disclosure.

FIG. 3 is a flowchart of a model training method according to another aspect of the disclosure.

FIG. 4 is a flowchart of a model training method according to another aspect of the disclosure.

FIG. 5 is a flowchart of a model training method according to another aspect of the disclosure.

FIG. 6 is a flowchart of a model training method according to another aspect of the disclosure.

FIG. 7 is a flowchart of a model training method according to another aspect of the disclosure.

FIG. 8 is a flowchart of a model training method according to another aspect of the disclosure.

FIG. 9 is a flowchart of a model training method according to yet another aspect of the disclosure.

FIG. 10 is a flowchart of a defect detection method according to an aspect of the disclosure.

FIG. 11 is a schematic structural diagram of a model training apparatus according to an aspect of the disclosure.

FIG. 12 is a schematic structural diagram of a model training apparatus according to another aspect of the disclosure.

FIG. 13 is a schematic structural diagram of a model training apparatus according to yet another aspect of the disclosure.

FIG. 14 is a schematic structural diagram of a defect detection apparatus according to an aspect of the disclosure.

FIG. 15 is a schematic structural diagram of a server according to an aspect of the disclosure.

### DETAILED DESCRIPTION

Aspects of the disclosure provide a model training method. In the model training method, an initial detection model is trained by using a subset of trained historical training data (a first sampled image set) and full newly added training data (a second training image set), which saves more time and reduces graphics processing unit (GPU) computational resource consumption compared to training the initial detection model by using the full historical training data and the full newly added training data. Updating of model parameters with the historical training data is constrained by using a first weight that adaptively evaluates the model parameters. Thus, a problem of catastrophic forgetting caused by fine tuning the model by using only the full newly added training data is solved, and a learning capability of the detection model is improved. The optimized detection model obtained by using the model training method is employed to detect a defect in a to-be-detected image, so that defect identification effect and accuracy are improved.

Terms such as “first”, “second”, “third”, and “fourth” (if any) in the specification and claims of the disclosure and in the accompanying drawings are configured for distinguishing similar objects and not necessarily configured for describing any particular order or sequence. Data used in this way is exchangeable in a proper case, so that the aspects of the disclosure described herein can be implemented in an order different from the order shown or described herein. In addition, the terms “include”, “corresponding to” and any other variants are intended to cover the non-exclusive inclusion. For example, a process, method, system, product, or device that includes a series of steps or units is not necessarily limited to those expressly listed steps or units, but may include other steps or units not expressly listed or inherent to such a process, method, product, or device.

In the aspect of the disclosure, the term “module” or “unit” refers to a computer program with a preset function or a part of the computer program and works, together with other related parts, to implement a preset target, and may be implemented or partially implemented by using software, hardware (for example, a processing circuit or a memory) or a combination thereof. Similarly, one processor (or a plurality of processors or memories) may be configured to implement one or more modules or units. In addition, each module or unit may be a part of an integrated module or unit including a function of the module or unit.

For ease of understanding of the technical solutions provided in aspects of the disclosure, some key terms used in the aspects of the disclosure are explained below first.

Descriptions of terms in the disclosure are provided as examples only and are not intended to limit the scope of the disclosure.

A defect detection technology may include a technology for determining a type of a defect in a collected image based on the collected image. In modern industrial manufacturing, there is an inevitable probability that some defective products may appear among various produced parts. Detecting these defective products through the defect detection technology plays a crucial role in improving production processes and enhancing factory efficiency.

Incremental learning may refer to a learning system capable of continuously learning new knowledge from a new sample and retaining most of the previously learned knowledge. Incremental learning is very similar to a learning mode of humans. In a growth process, humans learn and receive new things every day, and learning takes place gradually. Moreover, humans may not forget the knowledge that has been learned. In the aspects of the disclosure, the defect detection model is trained by using the incremental learning. Since a quantity of defects is continuously updated in different production periods, the defect detection model further needs to continuously learn from new defect images.

Incremental learning may include a data-incremental scenario and a class-incremental scenario.

The data-incremental scenario may refer to a scenario in which data class distributions are substantially identical across different incremental stages, and only a data volume increases. In the aspects of the disclosure, data-incremental learning is employed for training the defect detection model. Since the quantity of defects is continuously updated in different production periods, the defect detection model further needs to continuously learn from new defect images.

The class-incremental scenario may refer to a scenario in which data classes do not overlap between different incremental stages.

A full-data model may refer to a deep learning model obtained by performing model training iterations by using all accumulated data.

An incremental-data model may refer to a model obtained by performing training iterations by using a subset of existing data and newly added data or by using only newly added data without using the existing data.

Catastrophic forgetting may refer to a phenomenon in incremental learning where a model loses the ability to perform previously learned tasks when learning new tasks. In an example, when the model learns a new task, the model may adjust own parameters to meet requirements of the new task. However, adjustment of these parameters may lead to performance degradation of the model on a previously learned task, or may even cause a previously learned task to be substantially forgotten. Catastrophic forgetting is an important issue in incremental learning, and constrains an application range of incremental learning. There are two primary reasons for the catastrophic forgetting: a first reason is a parameter interference, and to be specific, parameter adjustment of a new task interferes with parameter adjustment of an old task, causing information of the old task to be lost. A second reason is representation space limitation, namely, a representation space of a model is finite, and information of multiple tasks cannot be represented simultaneously.

A design idea of the aspects of the disclosure is briefly described below.

In industrial manufacturing, there is an inevitable probability that some defective products may appear among various parts produced by enterprises. In an aspect, to ensure product quality, enterprises need to detect defective products for subsequent processing; and in another aspect, finding defective products and analyzing various types of defect morphological features and ratios are of great importance for improving a production process and improving yield of a production line.

In a traditional industrial manufacturing process, enterprises usually perform defect detection and classification on the products in a manual observation manner. However, for quality inspection personnel, the manual observation manner leads to problems such as high work intensity and monotonous tasks, resulting in a high employee turnover rate; and for enterprises, the manual observation manner causes problems such as high inspection cost (labor costs) and low quality inspection efficiency. However, in a case of sufficient data, the machine learning technology can outperform manual quality inspection in terms of accuracy, and greatly replace manual quality inspection to reduce cost and improve efficiency for the enterprises.

Currently, a deep learning-based defect detection technology can achieve relatively high precision. In an example, a large amount of training data is acquired in advance for model training, and then a trained neural network model is employed to perform defect detection. An example in which industrial quality inspection is performed on strip steel is used. During industrial quality inspection for the strip steel, defect detection is usually performed on an image of the strip steel, to detect and identify defects of the strip steel. In an example, in a deep learning-based defect detection method, a large amount of strip steel image data is trained to build a defect detection model, and an image of a strip steel surface is analyzed and identified by using a defect detection model for defect detection.

Since the related machine learning technology follows a batch learning mode, namely, it is assumed that all training samples may be available at once before training, and after learning these samples, the learning process terminates without acquiring new knowledge. However, as industrial quality inspection projects proceed, the volume of data collected for training the deep learning model gradually increases. For a same defect class, historical training data and newly added data need to be organized together, and a new model is re-trained by using the obtained full training data, to ensure that the new model can accurately identify a defect of this class.

In the related example, two technical solutions are mainly employed: performing model iteration by using full training data and performing model fine tuning by using incremental data.

Model iteration performed by using full training data refers to, in a full-data incremental scenario, performing iterative training on a model by using full historical training data for training a current model and newly added data together as complete training data of the model. This method may stably improve and iterate the model. However, as the data volume increases, training time and cost may further increase. If the data volume is very large, both computational resources and time cost required for training are very high.

Model fine tuning performed by using incremental data refers to performing fine tuning on an existing model by only using newly added data. Therefore, when the model is trained, to preserve the existing capabilities of the model, a relatively small learning rate may be used or only bottom layers of the deep learning model are trained. Since historical data is excluded from the fine tuning process, although a learning rate and a training parameter range are reduced, the model still faces the risk of catastrophic forgetting. This leads to a degradation in overall performance and over-fitting to the current data. As the quantity of fine-tuning iterations increases, this risk increases significantly.

To solve the problem of high computational resource consumption and time costs required for full-data model iteration and the problem of catastrophic forgetting of the historical data during model fine-tuning based on incremental data, which leads to a rapid degradation in overall performance of the model and insufficient stability, a transfer learning algorithm and an incremental learning algorithm have emerged as solutions.

Transfer learning refers to a method of transferring a capability of one model to a target domain. In an example, the target domain differs significantly from a source domain of the model, and performance on the source domain is often disregarded. Consequently, models subjected to transfer learning usually experience a substantial degradation in performance on original data. However, in a practical service processed in the aspects of the disclosure, newly added data usually exhibits no significant domain shift from the original data, and maintaining the performance on the original data is a critical requirement in the practical service. Therefore, these methods are not suitable.

Incremental learning is mainly configured for incremental task learning. Although data incremental learning is a special variant, related studies are limited. Existing transfer learning and incremental learning technologies have not achieved optimal results in practical service scenarios, and are relatively complicated to deploy.

In view of the above, the disclosure provides a model training method and a related apparatus. The model training method includes: firstly, acquiring a first training image set, a second training image set, and an initial detection model, where the initial detection model is trained based on the first training image set, the first training image set includes sample defect images, the second training image set includes sample defect images that are different from the sample defect images included in the first training image set, the initial detection model includes a first weight parameter set, the first weight parameter set includes a first weight parameter of a plurality of model parameters in the initial detection model, and the first weight parameter is configured for representing importance of the model parameters of the initial detection model; and then, training the initial detection model based on a first sampled image set, the second training image set, and the first weight parameter, to adjust the model parameters of the initial detection model, to obtain a trained optimized detection model, where the first sampled image set includes a portion of sample defect images in the first training image set, and the first weight parameter set is configured for constraining an adjustment range of the model parameters in the initial detection model. In the model training method provided in an aspect of the disclosure, the initial detection model is trained by using a subset of trained first sampled image sets and the full newly added second training image set, which saves more time and reduces GPU computational resource consumption compared to training the initial detection model by using the full historical training data and the full newly added training data. By adaptively evaluating the model parameters to determine corresponding first weights, the update of the model parameters relative to the historical training data is constrained. Compared to fine tuning the model by only using the full newly added data, which causes catastrophic forgetting, the method improves a learning capability of the model, and enhances defect identification effect and accuracy of the model.

Furthermore, an aspect of the disclosure further provides a defect detection method and a related apparatus. The defect detection method includes: firstly, acquiring a to-be-detected image; then, inputting the to-be-detected image into an optimized detection model, where the optimized detection model includes a feature extraction network and a classification network, and the optimized detection model is obtained by using the foregoing model training method; next, performing feature extraction on the to-be-detected image based on the feature extraction network in the optimized detection model, to obtain a to-be-detected image feature; and finally, performing defect classification on the to-be-detected image feature based on the classification network, to obtain predicted defect information of the to-be-detected image, where the predicted defect information is configured for representing a classification result of whether the to-be-detected image includes a defect. In the defect detection method provided in an aspect of the disclosure, the optimized detection model obtained by using the model training method is employed to detect the defect in the to-be-detected image, and obtain the classification result of whether the to-be-detected image includes the defect, so that the defect identification effect and accuracy are improved.

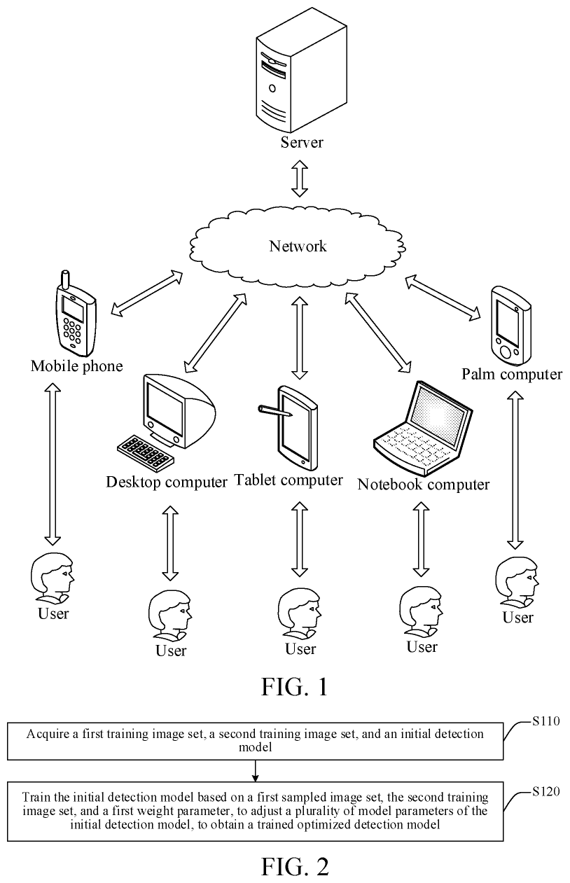

For ease of understanding, FIG. 1 is a diagram of an application environment of a model training method or a defect detection method according to an aspect of the disclosure. As shown in FIG. 1, the model training method in an aspect of the disclosure is applied to a model training system, and the defect detection method is applied to a defect detection system. The model training system includes a server and a terminal device. The server may be an independent physical server, or may be a server cluster including a plurality of physical servers or a distributed system. Alternatively, the server may be a cloud server that provides basic cloud computing services such as a cloud service, a cloud database, cloud computing, a cloud function, cloud storage, a network service, cloud communication, a middle-ware service, a domain name service, a security service, a content delivery network (CDN), big data, and an artificial intelligence platform. The terminal may be a smart phone, a tablet computer, a notebook computer, a desktop computer, a smart speaker, a smart watch, and the like, but is not limited thereto. The terminal and the server may be directly or indirectly connected through wired or wireless communication. This is not limited in aspects of the disclosure.

First, the server acquires a first training image set, a second training image set, and an initial detection model, where the initial detection model is trained based on the first training image set, the first training image set includes sample defect images, the second training image set includes sample defect images that are different from the sample defect images included in the first training image set, the initial detection model includes a first weight parameter set, the first weight parameter set includes a first weight parameter of a plurality of model parameters in the initial detection model, and the first weight parameter is configured for representing importance of the model parameters of the initial detection model. Then, the server trains the initial detection model based on a first sampled image set, the second training image set, and the first weight parameter, to adjust the model parameters of the initial detection model, to obtain a trained optimized detection model, where the first sampled image set includes a portion of sample defect images in the first training image set, and the first weight parameter set is configured for constraining an adjustment range of the model parameters in the initial detection model.

The following describes the model training method in the disclosure from a perspective of the server. Referring to FIG. 2, a model training method provided in an aspect of the disclosure includes operation S110 to operation S120. Details are as follows:

At S110, a first training image set, a second training image set, and an initial detection model are acquired.

The initial detection model is trained based on the first training image set, the first training image set includes a first sample defect image, the second training image set includes a second sample defect image, the second sample defect image is different from the first sample defect image, the initial detection model includes a first weight parameter set, the first weight parameter set includes a first weight parameter of a plurality of model parameters in the initial detection model, and the first weight parameter is configured for representing importance of the plurality of model parameters of the initial detection model.

The first training image set includes at least one first sample defect image, and these images are underlying data for training the initial detection model. The second training image set includes at least one second sample defect image sampled within a production cycle, and includes data of overkilling and missed detection situations that occur in a process of performing actual defect detection by using the initial detection model. The initial detection model is a model that is trained based on the first training image set. The initial detection model has a feature extraction network and a classification network, and may identify a product quality defect in an image. Details are as follows:

The sample defect image in the first training image set is full training data when the initial detection model is trained. The initial detection model is trained based on the first training image set. The initial detection model may identify a defect of a product, such as strip steel, in an image. The initial detection model includes a feature extraction network and a classification network. The feature extraction network is configured to perform feature extraction on an image inputted into the initial detection model, and the classification network is configured to classify image features, to obtain a predicted result of whether the product in the image includes a defect. The classification network in the initial detection model has a first weight parameter set. The first weight parameter set may be in a matrix form, or may be in a set form. The first weight parameter set includes a plurality of first weight parameters. Each weight parameter corresponds to one model parameter in the classification network. Therefore, the first weight parameter is configured for representing importance of the model parameters of the initial detection model for quality defect identification.

After the initial detection model is deployed online, with application of the initial detection model, some cases of overkilling and missed detection may occur. Overkilling refers to a case in which an initial detection model erroneously determines a normal product or sample as a defective or unqualified product or sample. This refers to that the initial detection model makes excessive judgment on normal products, and erroneously determines the product as a defective product. Missed detection refers to that the initial detection model fails to detect an actually defective or unqualified product or sample. This refers to that the model misses some defective products that need to be detected, leading to missed detection. The volume of data generated by overkilling and missed detection is less than the volume of data in the first training image set trained before the initial detection model is deployed online. However, the data is still critical for optimization and performance improvement of the initial detection model. Therefore, after the initial detection model is used online for a period of time, statistics collection and sampling are performed on overkilling and missed detection cases within a production period, to obtain the second training image set.

At S120, the initial detection model is trained based on a first sampled image set, the second training image set, and the first weight parameter. The initial detection model is trained to adjust a plurality of model parameters of the initial detection model so as to obtain a trained optimized detection model.

The first sampled image set includes a portion of sample defect images in the first training image set, and the first weight parameter set is configured for constraining an adjustment magnitude of the model parameters in the initial detection model.

The first sampled image set is obtained by sampling the sample defect images from the first training image set based on a sampling ratio. A sampling objective is to reduce a scale of training data and reserve important information. The sample defect images in the first sampled image set sampled from the first training image set serves as training samples of the initial detection model together with the sample defect images from the second training image set for further training the initial detection model. Compared to training the initial detection model by using the full first training image set and second training image set, time for training the initial model is reduced, and GPU computational resource consumption is reduced.

The initial detection model is fine-tuned by using the first sampled image set and the second training image set, to obtain the trained optimized detection model. In a process of fine tuning the initial detection model, for the model parameters that are very important in the initial detection model, namely, the model parameters that have an important impact on accurate identification of a defect involved in the first training image set, during this training, with accurate indication of the first weight parameter set, a parameter adjustment range of these model parameters is relatively constrained, so that the trained optimized detection model does not excessively forget previously learned knowledge, and can maintain identification accuracy for the defect that can be identified originally. Therefore, by using the first weight parameter set to impose targeted constraint on updating of the model parameters in the initial detection model, the updating magnitude of important model parameters in the initial detection model is constrained, so that the previously learned knowledge is ensured not to be excessively forgotten during the fine-tuning process. The optimized detection model obtained in this way can produce correct detection results for situations where the original initial detection model may experience overkilling and missed detection, so that the accuracy of defect detection is improved.

Some model parameters in an initial model can play a decisive role (have high importance) in accurately identifying a sample class (for example, whether the sample has a defect), and some model parameters may have limited impact (low importance). To be specific, for inputted images (such as the first sample defect image) that can be accurately identified originally, if a large variation occurs in the important model parameters, the identification accuracy of the initial model for these images is directly affected.

In an example, higher importance identified by the first weight parameter of one model parameter indicates a smaller adjustment magnitude of the model parameter in a model training stage.

In the method provided in an aspect of the disclosure, the initial detection model is optimized by using sampled data and a weight constraint, to solve the problems of overkilling and missed detection, and improve performance of the model. This method may effectively improve model effect with finite computational resources. In a practical application, the sampling ratio and a training policy need to be appropriately set based on a specific situation, to achieve an optimal detection effect.

For ease of understanding, the initial detection model that is deployed online at a moment t can be represented by

$${θ}_{t}^{i} ,$$

where t denotes a time node at which the initial detection model is deployed online, i denotes a model parameter in the initial detection model, and the initial detection model

$${θ}_{t}^{i}$$

is obtained by performing training on all sample defect data in the first training image set D_{1:t}. After the initial detection model is deployed online for a period of time, a time node is t+1, statistics collection is performed on overkilling data and missed detection data of the initial detection model, to obtain a second training image set Dₜ₊₁. In the related example, full training data is usually used, i.e., D_{1:t}+Dₜ₊₁. In the method provided in an aspect of the disclosure, the sampling ratio p % of the first training image set is determined. Sample defect images are sampled from the first training image set D_{1:t} based on the sampling ratio p %, to obtain a first sampled image set. The first sampled image set and the second training image set Dₜ₊₁ are merged to form new training data

$${D}_{t + 1}^{′} .$$

The initial detection model

$${θ}_{t}^{i}$$

is trained by using the training data

$${D}_{t + 1}^{′}$$

obtained by merging the first sampled image set and the second training image set Dₜ₊₁, to adjust model parameters of the initial detection model, to obtain a trained optimized detection model

$${θ}_{t + 1}^{i} .$$

In the model training method provided in an aspect of the disclosure, the initial detection model is trained by using some trained first training image sets and the full newly added second training image set, which saves more time and reduces GPU computational resource consumption compared to training the initial detection model by using the full historical training data and the full newly added training data. An updating magnitude of the training data for some important model parameters is constrained by using a first weight adaptively evaluating the model parameters, so that compared to fine tuning the model by only using the full newly added data, causing catastrophic forgetting problem, a learning capability of the model is improved, and defect identification effect and accuracy of the model are enhanced.

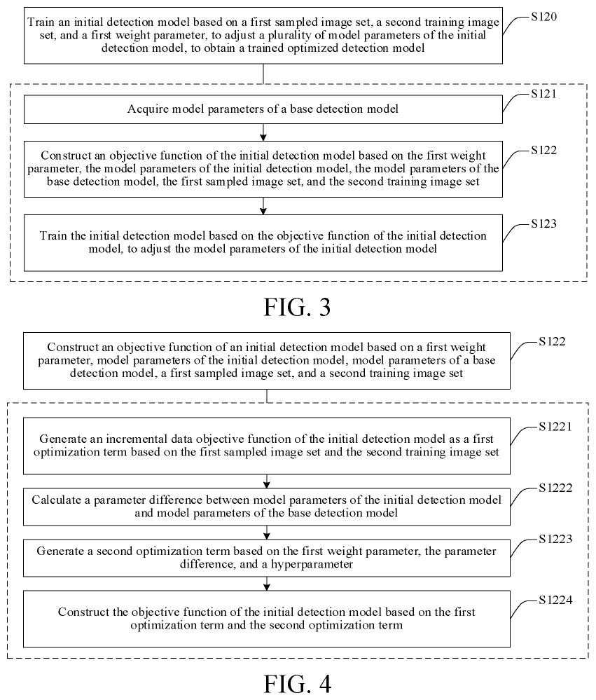

In an aspect of a model training method provided by FIG. 2 of the disclosure, referring to FIG. 3, operation S120 further includes a sub-operation S121 to a sub-operation S123. Details are as follows:

At S121, model parameters of a base detection model are acquired.

The initial detection model is obtained by adjusting the model parameters of the base detection model. For example, the initial detection model may be obtained by training the base detection model based on the first training image set.

In some examples, the base detection model that is deployed online at a moment t−1 can be represented by

$${θ}_{t - 1}^{i} ,$$

where t−1 denotes a time node at which the base detection model is deployed online, i denotes a model parameter in the base detection model, and the base detection model

$${θ}_{t - 1}^{i}$$

is obtained by performing training on all sample defect data in previous base training image sets Dₜ₋₁. After the base detection model is deployed online for a period of time, a time node is t, and statistics collection is performed on overkilling data and missed detection data, to obtain a third training image set. A sampling ratio p % of the base training image set Dₜ₋₁ is determined. Sample defect images are sampled from the base training image set Dₜ₋₁ based on the sampling ratio p %, to obtain a second sampled image set. The second sampled image set and the third training image set are merged to form new training data. The base detection model

$${θ}_{t - 1}^{i}$$

is by using us new training data obtained by merging the second sampled image set and the third training image set, to adjust the model parameters of the base detection model, to obtain a trained initial detection model

$${θ}_{t}^{i} .$$

At S122, an objective function of the initial detection model is calculated based on the first weight parameter, the model parameters of the initial detection model, the model parameters of the base detection model, the first sampled image set, and the second training image set.

The objective function of the initial detection model is calculated based on the first weight parameter, the model parameters of the initial detection model, the model parameters of the base detection model, the first sampled image set, and the second training image set. The objective function is usually an index configured for evaluating model performance, and may be an accuracy rate, a misclassification rate, a recall rate, or the like. Calculating the objective function aims at quantitatively evaluating performance of the initial detection model on the second training image set.

At S123, the initial detection model is trained based on the objective function of the initial detection model, to adjust the model parameters of the initial detection model.

For ease of understanding, the objective function of the initial detection model may be calculated by using the following formula (1):

$${L}_{t + 1} = \frac{λ}{2} \sum {w}_{t}^{i} {( {θ}_{t}^{i} - {θ}_{t - 1}^{i} )}^{2} - log p ( {D}_{t + 1}^{′} \vert θ ) , \qquad ( 1 )$$

where Lₜ₊₁ denotes the objective function of the initial detection model corresponding to a time node t+1. λ is an adjustable hyperparameter, and is configured for controlling adaptability of the detection model (a learning capability for a new task at a moment t+1) and stability (a memory capability for an old task at a moment t).

$${w}_{t}^{i}$$

denotes a first weight parameter set corresponding to the initial detection model at the moment t. The first weight parameter set includes a first weight parameter of a plurality of model parameters in the initial detection model. The first weight parameter is configured for representing importance of the model parameters of the initial detection model, and importance of the plurality of model parameters of the initial detection model for an old task may be measured by using a first weight, and an importance weight is obtained by iteration.

$${θ}_{t}^{i}$$

denotes a model parameter of the initial detection model at the moment t.

$${θ}_{t - 1}^{i}$$

denotes a model parameter of the base detection model at the moment t−1.

$$p ( {D}_{t + 1}^{′} \vert θ )$$

denotes a probability function.

$${D}_{t + 1}^{′}$$

denotes data formed by merging the first sampled image set and the second training image set Dₜ₊₁. θ denotes a model parameter of the base detection model.

After the initial detection model is fine-tuned by using the second training image set Dₜ₊₁ to obtain an optimized detection model

$${θ}_{t + 1}^{i} ,$$

calculation is performed on full training data in all epochs to ensure that the full training data may be accessed, thereby learning the importance of the model parameter for a current task. In this case, each iteration includes forward propagation and back propagation. However, in a process of learning the importance of the parameter, the model is not updated based on a gradient descent algorithm during the back propagation.

In the method provided in an aspect of the disclosure, the initial detection model is adjusted and optimized more finely by using the objective function. Calculating the objective function provides quantitative evaluation on performance of the model on a data set, such as a predefined data set. This process may help us to find a better model configuration and improve accuracy and reliability of the model. In a practical application, an appropriate objective function and weight calculation method needs to be selected based on a specific problem and data characteristics. In addition, a plurality of experiments and verifications further need to be performed to find an optimal parameter setting and model structure. Fine adjustment and optimization of these operations are to enable the model to better adapt to changes and requirements of data during practical application, and improve the performance and generalization capability of the model.

In an aspect of the model training method provided in FIG. 3 of the disclosure, referring to FIG. 4, sub-operation S122 further includes sub-operation S1221 to sub-operation S1224. Details are as follows:

At S1221, an incremental-data objective function of the initial detection model is generated as a first optimization term based on the first sampled image set and the second training image set.

The incremental-data objective function of the initial detection model may be calculated by using the following formula (2):

$${L}_{Z T} = - log p ( {D}_{t + 1}^{′} \vert θ ) , \qquad ( 2 )$$

where

$$p ( {D}_{t + 1}^{′} \vert θ )$$

denotes a probability function.

$${D}_{t + 1}^{′}$$

denotes data formed by merging the first sampled image set and the second training image set Dₜ₊₁. θ denotes a model parameter of a base detection model.

The incremental-data objective function may reflect a loss function when the initial detection model is trained by using training samples including the first sampled image set and the second training image set.

At S1222, parameter differences between model parameters of the initial detection model and model parameters of the base detection model are calculated. A first one of the parameter differences is obtained based on a first one of the model parameters of the initial detection model and a first one of the model parameters of the base detection mode that corresponds to the first one of the model parameters of the initial detection model.

The parameter difference between the model parameters of the initial detection model and the model parameters of the base detection model may reflect a parameter numerical difference between the model parameters of the two detection models.

The parameter difference between the model parameters of the initial detection model and the model parameters of the base detection model may be calculated by using the following formula (3):

$${θ}^{i} = {θ}_{t}^{i} - {θ}_{t - 1}^{i} , \qquad ( 3 )$$

where θⁱ denotes the parameter difference between the model parameters of the initial detection model and the model parameters of the base detection model, and

$${θ}_{t}^{i}$$

denotes a moder parameter of the initial detection model at the moment t.

$${θ}_{t - 1}^{i}$$

denotes a model parameter of the base detection model at the moment t−1.

At S1223, a second optimization term is generated based on the first weight parameter, the parameter difference, and the hyperparameter.

The second optimization term is configured for constraining an adjustment magnitude of an important parameter during training. For example, the important parameter can include

$${θ}_{t}^{i} ,$$

$${θ}_{t - 1}^{i} ,$$

$$or$$

$${θ}^{i} .$$

important parameter may be identified by using the first weight parameter. In an example, the important parameter is θⁱ and identified by the first weight parameter

$${w}_{t}^{i}$$

$$as$$

$${w}_{t}^{i} ( {θ}_{t}^{i} - {θ}_{t - 1}^{i} ) .$$

the hyperparameter λ is configured for identifying an impact degree of the second optimization term when training the initial detection model.

At S1224, an objective function of the initial detection model is constructed based on the first optimization term and the second optimization term.

The hyperparameter λ is an adjustable hyperparameter, and is configured for controlling adaptability of the detection model (a learning capability for a new task at a moment t+1) and stability (a memory capability for an old task at a moment t).

In some aspects, the second optimization term may be generated based on the first weight parameter, the parameter difference, and the hyperparameter, and the objective function may be constructed based on the first optimization term and the second optimization term in the following mode:

The hyperparameter and the first weight parameter are multiplied by a quadratic result of the parameter difference, and a multiplication result and the incremental-data objective function of the initial detection model are added, to obtain the objective function of the initial detection model.

The objective function of the initial detection model may be calculated by using the following formula (4):

$${L}_{t + 1} = \frac{λ}{2} \sum {{w}_{t}^{i} ( {θ}_{t}^{i} - {θ}_{t - 1}^{i} )}^{2} - log p ( {D}_{t + 1}^{′} \vert θ ) , \qquad ( 4 )$$

where Lₜ₊₁ denotes the objective function of the initial detection model corresponding to a time node t+1. λ is an adjustable hyperparameter.

$${w}_{t}^{i}$$

denotes a first weight parameter set corresponding to the initial detection model at the moment t. Importance of a model parameter of the initial detection model for an old task may be measured by using the first weight parameter set, and weight parameters in the first weight parameter set may be obtained by iteration

$${θ}_{t}^{i}$$

denotes a model parameter of the initial detection model at the moment t.

$${θ}_{t - 1}^{i}$$

denotes a model parameter of the base detection model at the moment t−1.

$$p ( {D}_{t + 1}^{′} \vert θ )$$

denotes a probability function.

$${D}_{t + 1}^{′}$$

denotes data formed by merging the first sampled image set and the second training image set Dₜ₊₁. θ denotes a model parameter of a base detection model.

In the method provided in an aspect of the disclosure, the objective function of the initial detection model is calculated by processing sampled data, comparing the model parameters, and using weights. The objective function may be used as an index for evaluating model performance, help us to know performance of the model on a particular data set, and instruct further optimization and improvement. This calculation process may help us to evaluate and improve the detection model more accurately, to improve the performance and accuracy of the detection model.

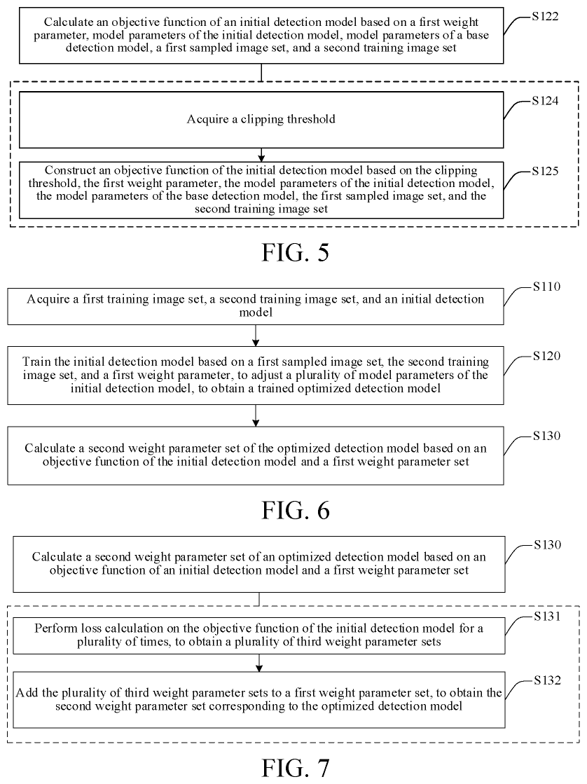

In an aspect of a model training method provided by FIG. 3 of the disclosure, referring to FIG. 5, operation S122 further includes sub-operation S124 to sub-operation S125.

At S124, a clipping threshold is acquired. The clipping threshold is configured for representing a gradient threshold when parameters of the initial detection model are updated, to constrain a gradient range when the parameters of the initial detection model are updated.

At S125, an objective function of the initial detection model is constructed based on the clipping threshold, the first weight parameter, the model parameters of the initial detection model, the model parameters of the base detection model, the first sampled image set, and the second training image set.

In an example, operation S125 includes the following three operations (1)-(3):

At operation (1), a square root of the first weight parameter is calculated, a parameter difference between the model parameters of the initial detection model and the model parameters of the base detection model is calculated, and the square root of the first weight parameter is multiplied by the parameter difference, to obtain a first calculation value.

At operation (2), if the first calculation value is less than or equal to the clipping threshold, an objective function of the initial detection model is calculated based on the first weight parameter, the model parameters of the initial detection model, the model parameters of the base detection model, the first sampled image set, and the second training image set.

At operation (3), if the first calculation value is greater than the clipping threshold, an objective function of the initial detection model is calculated based on the clipping threshold, the first weight parameter, the model parameters of the initial detection model, the model parameters of the base detection model, the first sampled image set, and the second training image set.

The objective function of the initial detection model may be calculated by using the following formula (5):

$${L}_{t + 1} = \frac{λ}{2} \sum {{w}_{t}^{i} ( {θ}_{t}^{i} - {θ}_{t - 1}^{i} )}^{2} - log p ( {D}_{t + 1}^{′} \vert θ ) , \qquad ( 5 )$$

A hyperparameter λ in formula (5) is actually configured for balancing a memory capability for an old task and a learning capability for a new task, namely, configured for controlling adaptability of the detection model (the learning capability for a new task at a moment t+1) and stability (the memory capability for an old task at a moment t). When λ=0, optimization of the model actually refers to a most common fine tuning mode. This may lead to catastrophic forgetting. When λ is equal to positive infinity, a new model always keeps parameters the same as those of the old model, and therefore, the model cannot learn from a new task. In a practical service, in the disclosure, when λ takes a value such as 0.2, 0.4, 1, or 2, it is found that the model accuracy becomes higher. However, when λ reaches 10, training becomes extremely unstable. Consequently, the disclosure cannot continue to search for an optimal balance between new and old tasks. Through further observation, before training gradient explosion occurs, gradients of some parameters become extremely large.

Taking one single parameter θ in formula (5) as an example, a gradient of a quadratic term

$${{w}_{t}^{i} ( {θ}_{t}^{i} - {θ}_{t - 1}^{i} )}^{2}$$

with respect to θ is

$${w}_{t}^{i} ( {θ}_{t}^{i} - {θ}_{t - 1}^{i} ) .$$

Due to significant differences in data distribution across different tasks, the model parameters may undergo rapid adaptation in an initial stage of incremental fine tuning to align with a new data distribution. In this case, the gradient tends to increase dramatically, eventually leading to gradient explosion. To solve this problem, the following manner is used in the disclosure to constrain the gradient within an appropriate range. In an example, the quadratic term in formula (5) is replaced with formula (6):

$${L}_{β} ( θ ) = \{ \begin{matrix}\frac{1}{2} {{w}_{t}^{i} ( {θ}_{t}^{i} - {θ}_{t - 1}^{i} )}^{2} , & \sqrt{{w}_{t}^{i}} \vert {θ}_{t}^{i} - {θ}_{t - 1}^{i} \vert \leq β \\ β ( \sqrt{{w}_{t}^{i}} \vert {θ}_{t}^{i} - {θ}_{t - 1}^{i} \vert - \frac{β}{2} ) , & \sqrt{{w}_{t}^{i}} \vert {θ}_{t}^{i} - {θ}_{t - 1}^{i} \vert > β\end{matrix} , \qquad ( 6 )$$

Where β denotes a hyperparameter, and represents a preset clipping threshold. Namely, when a gradient exceeds this threshold, a restrictive measure needs to be taken.

Therefore, case-by-case calculation needs to be performed on the objective function of the initial detection model. In an example, the root of the first weight parameter is first calculated, the parameter difference between the model parameters of the initial detection model and the model parameters of the base detection model is calculated, and the root of the first weight parameter is multiplied by the parameter difference, to obtain the first calculation value. If the first calculation value is less than or equal to the clipping threshold, the objective function of the initial detection model is calculated based on the first weight parameter, the model parameters of the initial detection model, the model parameters of the base detection model, the first sampled image set, and the second training image set. If the first calculation value is greater than the clipping threshold, the objective function of the initial detection model is calculated based on the clipping threshold, the root of the first weight parameter, the model parameters of the initial detection model, the model parameters of the base detection model, the first sampled image set, and the second training image set.

The objective function of the initial detection model may be represented by using the following formula (7):

$$( 7 )$$

$${L}_{t + 1} = \{ \begin{matrix}\frac{λ}{2} \sum \frac{1}{2} {{w}_{t}^{i} ( {θ}_{t}^{i} - {θ}_{t - 1}^{i} )}^{2} - log p ( {D}_{t + 1}^{′} \vert θ ) , & \sqrt{{w}_{t}^{i}} \vert {θ}_{t}^{i} - {θ}_{t - 1}^{i} \vert \leq β \\ \frac{λ}{2} \sum β ( \sqrt{{w}_{t}^{i}} \vert {θ}_{t}^{i} - {θ}_{t - 1}^{i} \vert - \frac{β}{2} ) - log p ( {D}_{t + 1}^{′} \vert θ ) , & \sqrt{{w}_{t}^{i}} \vert {θ}_{t}^{i} - {θ}_{t - 1}^{i} \vert > β\end{matrix}$$

By taking a derivative of θ with formula (6), the following formula (8) may be obtained:

$$\frac{d {L}_{β} ( θ )}{d θ} = \{ \begin{matrix}{w}_{t}^{i} ( {θ}_{t}^{i} - {θ}_{t - 1}^{i} ) , & \sqrt{{w}_{t}^{i}} \vert {θ}_{t}^{i} - {θ}_{t - 1}^{i} \vert \leq β \\ β \sqrt{{w}_{t}^{i}} \frac{{θ}_{t}^{i} - {θ}_{t - 1}^{i}}{\vert {θ}_{t}^{i} - {θ}_{t - 1}^{i} \vert} , & \sqrt{{w}_{t}^{i}} \vert {θ}_{t}^{i} - {θ}_{t - 1}^{i} \vert > β\end{matrix} \qquad ( 8 )$$

It can be known from formula (8) that, the gradient is effectively constrained within a range

$$[ - β \sqrt{{w}_{t}^{i}} , β \sqrt{{w}_{t}^{i}} ] . When \sqrt{{w}_{t}^{i}} \vert {θ}_{t}^{i} - {θ}_{t - 1}^{i} \vert \leq β ,$$

the objective function of the initial detection model may be calculated by using formula (7).After the aforementioned modifications, λ in formula (7) may take larger values, so that the model achieves better performance, and the gradient explosion may be avoided.

The problem of gradient explosion when λ is large may further be solved through gradient clipping, and may be implemented by using the following formula (9):

$$\hat{{g}_{ι}} = \frac{{β}_{g}}{max ( {β}_{g} , ‖ g ‖ )} {g}_{i} , \qquad ( 9 )$$

where g denotes a gradient vector of the loss function with respect to the parameter θ, gᵢ denotes a specific term in this vector, and β_{g} denotes a clipping threshold for a norm of g. Although gradient explosion may alternatively be prevented by using formula (9), learning effect of a final model is not the same as the effect of formula (6) and formula (7), because gradient clipping of all parameters in formula (9) is coupled, and a clipping ratio is fixed. In contrast, the solution using formula (7) is decoupled, and whether each gradient is clipped and a value after clipping is independent of another gradient depends solely on the importance of a current parameter for the old task.

In the method provided in an aspect of the disclosure, the optimized detection model is adjusted and optimized more finely by calculating the objective function. Calculating the objective function provides quantitative evaluation on performance of the model on a data set, such as a predefined data set. This process may help us to find a better model configuration and improve accuracy and reliability of the model. In a practical application, an appropriate objective function and weight calculation method needs to be selected based on a specific problem and data characteristics. In addition, a plurality of experiments and verifications further need to be performed to find an optimal parameter setting and model structure. Fine adjustment and optimization of these operations are to enable the model to better adapt to changes and requirements of data during practical application, and improve the performance and generalization capability of the model.

In an aspect of the model training method provided by FIG. 3 of the disclosure, referring to FIG. 6, after operation S120, operation S130 is further included.

At S130, a second weight parameter set of the optimized detection model is calculated based on the objective function of the initial detection model and the first weight parameter set.

The second weight parameter set includes a second weight parameter of a plurality of model parameters in the optimized detection model, the second weight parameter is configured for representing importance of the model parameters of the optimized detection model, and the second weight parameter set is configured for constraining an adjustment range of the model parameters in the optimized detection model.

The second weight parameter set is calculated based on the objective function and the first weight parameter set, and reflects performance of the optimized detection model and impact of different model parameters on the performance. By calculating the second weight parameter set, parameter importance of the model may be further adjusted and optimized, to improve the performance and generalization capability of the model, and provide a basis for subsequent training of the optimized detection model. When model iteration is performed subsequently by using newly added training data, a weight parameter corresponding to a model obtained after each iteration needs to be calculated, to constrain an adjustment range of the model parameter when the model iteration is performed.

The second weight parameter set corresponding to the optimized detection model may be calculated by using the following formula (10):

$${w}_{t + 1}^{i} = {w}_{t}^{i} + {\sum }_{j} {( {α}_{i} {L}_{t + 1}^{( j )} )}^{2} {\vert}_{{θ}_{t + 1}^{i} = {θ}_{t}^{i}} , t = 0 , 1 , 2 , … , {w}_{0}^{i} = 0 , \qquad ( 10 )$$

where

$${w}_{t + 1}^{i}$$

denotes the second weight parameter set corresponding to the optimized detection model,

$${w}_{t}^{i}$$

denotes the first weight parameter set corresponding to the initial detection model, and the first weight parameter set may further be obtained through iteration by using formula (10), j denotes a count of losses, and

$${α}_{i} {L}_{t + 1}^{( j )}$$

denotes a derivation of the objective function.

$${\sum }_{j} {( {α}_{i} {L}_{t + 1}^{( j )} )}^{2} {\vert}_{{θ}_{t + 1}^{i} = {θ}_{t}^{i}}$$

denotes a weight matrix representing the importance of the second training image set for the model parameters of the optimized detection model. This weight matrix is added with the weight matrix

$${w}_{t}^{i}$$

representing the importance of model parameters of the initial detection model to obtain a weight matrix

$${w}_{t + 1}^{i}$$

representing the importance of the model parameters of the optimized detection model, i.e., the second weight parameter set. This weight matrix represents the importance of the parameter with respect to all learned tasks. When the initial detection model is fine-tuned at a moment t+2, this weight matrix is configured for better retaining knowledge from moment 1 to moment t+1.

After the initial detection model is fine-tuned by using the second training image set Dₜ₊₁ to obtain the optimized detection model θⁱₜ₊₁, calculation is performed on full training data in all epochs to ensure that the full training data may be accessed during training, thereby learning the importance of the model parameter for a current task. In this case, each iteration includes forward propagation and back propagation. However, in a process of learning the importance of the parameter, the model is not updated based on a gradient descent algorithm during the back propagation.

In the method provided in an aspect of the disclosure, the optimized detection model is adjusted and optimized more finely by determining the second weight parameter set. The second weight parameter set is calculated to adjust parameter importance of the model based on an evaluation result. This process may help us to find a better model configuration and improve accuracy and reliability of the model. In a practical application, an appropriate objective function and weight calculation method needs to be selected based on a specific problem and data characteristics. In addition, a plurality of experiments and verifications further need to be performed to find an optimal parameter setting and model structure. Fine adjustment and optimization of these operations are to enable the model to better adapt to changes and requirements of data during practical application, and improve the performance and generalization capability of the model.

In an aspect of the model training method provided in FIG. 6 of the disclosure, referring to FIG. 7, operation S130 further includes sub-operation S131 to sub-operation S132. Details are as follows:

At S131, loss calculation is performed on the objective function of the initial detection model for a plurality of times to obtain a plurality of third weight parameter sets.

The loss calculation is performed by performing derivative calculation on the objective function of the initial detection model. The third weight parameter set includes a plurality of third weight parameters. The third weight parameters are configured for representing importance of the model parameters of the initial detection model for correctly identifying the second training image set.

A quantity of the third weight parameter sets may be related to a count of loss calculations. For example, at each loss calculation, a corresponding third weight parameter set may be obtained.

The third weight parameter set is a weight matrix representing importance of the second training image set for the model parameters of the optimized detection model, and may be expressed by using the following formula (11):

$$w = {\sum }_{j} {( {α}_{i} {L}_{t + 1}^{( j )} )}^{2} {\vert}_{{θ}_{t + 1}^{i} = {θ}_{t}^{i}} , \qquad ( 11 )$$

where

$${α}_{i} {L}_{t + 1}^{( j )}$$

denotes taking a derivative of the objective function.

At S132, the plurality of third weight parameter sets is added to the first weight parameter set, to obtain the second weight parameter set corresponding to the optimized detection model.

The second weight parameter set corresponding to the optimized detection model may be calculated by using the following formula (12):

$${w}_{t + 1}^{i} = {w}_{t}^{i} + {\sum }_{j} {( {α}_{i} {L}_{t + 1}^{( j )} )}^{2} {\vert}_{{θ}_{t + 1}^{i} = {θ}_{t}^{i}} , t = 0 , 1 , 2 , … , {w}_{0}^{i} = 0 , \qquad ( 12 )$$

where

$${w}_{t + 1}^{i}$$

denotes the second weight parameter set corresponding to the optimized detection model,

$${w}_{t}^{i}$$

denotes the first weight parameter set corresponding to the initial detection model, and the first weight may further be obtained through iteration by using formula (12), j denotes a count of losses, and

$${α}_{i} {L}_{t + 1}^{( j )}$$

denotes derivation of the objective function.

$${\sum }_{j} {( {α}_{i} {L}_{t + 1}^{( j )} )}^{2} {\vert}_{{θ}_{t + 1}^{i} = {θ}_{t}^{i}}$$

denotes a weight matrix representing the importance of the second training image set for the model parameters of the optimized detection model. This weight matrix is added with the weight matrix

$${w}_{t}^{i}$$

refreshening the importance of model parameters of the initial detection model to obtain a weight matrix

$${w}_{t + 1}^{i}$$

representing the importance of the model parameters of the optimized detection model, i.e., the second weight parameter set. This weight matrix represents the importance of the parameter with respect to all learned tasks. When the initial detection model is fine-tuned at a moment t+2, this weight matrix is configured for better retaining knowledge from moment 1 to moment t+1.

In the method provided in an aspect of the disclosure, importance of the model parameters of the optimized detection model are more accurately evaluated. This is conducive to improving performance and generalization capability of the model.

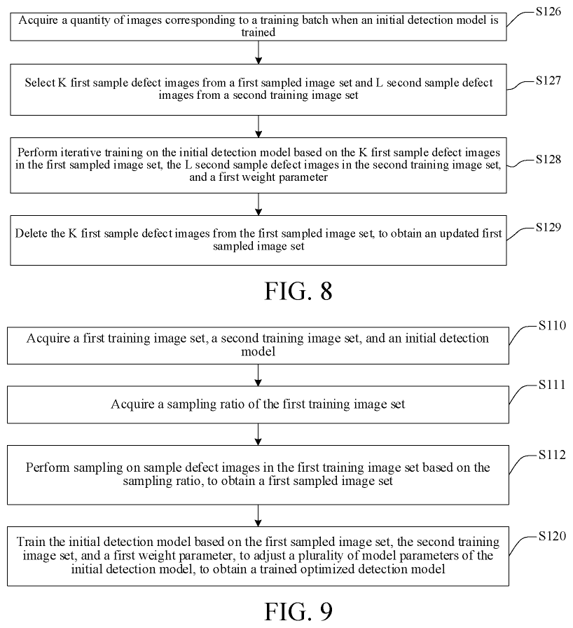

In an aspect of the model training method provided in FIG. 2 of the disclosure, referring to FIG. 8, operation S120 further includes sub-operation S126 to sub-operation S129. Details are as follows:

At S126, a quantity of images corresponding to a training batch is acquired when the initial detection model is trained.

The quantity of images is N, and N is an integer greater than 1.

The quantity of images corresponding to the training batch refers to the quantity of images of the training batch.

At S127, K first sample defect images are selected from the first sampled image set and L second sample defect images from the second training image set.

K and L are both integers greater than or equal to 1, and K+L=N.

The sample defect images are sampled from the first training image set D_{1:t} based on a sampling ratio p %, to obtain the first sampled image set, and the first sampled image set and the second training image set are merged together to form new training data. K sample defect images are selected from the first sampled image set, and L sample defect images are selected from the second training image set. In an example, K and L are controlled to be as equal as possible. In an example, K and L are defined as follows formulas (13) and (14):

$$K = ⌊ \frac{N}{2} ⌋ , \qquad ( 13 )$$

$$L = N - ⌊ \frac{N}{2} ⌋ , \qquad ( 14 )$$

where └·┘ denotes rounding down,

$$⌊ \frac{N}{2} ⌋$$

images are selected from the first sampled image set,

$$N - ⌊ \frac{N}{2} ⌋$$

images are selected from the second training image set, and the images are merged to form new training data

$${D}_{t + 1}^{′} .$$

At S128, iterative training is performed on the initial detection model based on the K first sample defect images in the first sampled image set, the L second sample defect images in the second training image set, and the first weight parameter.

At S129, the K first sample defect images are deleted from the first sampled image set, to obtain an updated first sampled image set.

The updated first sampled image set is used as a sampled set of the K sample defect images during iterative training.

To use K different sample defect images in the first sampled image set during each iterative training, the K sample defect images need to be deleted from the first sampled image set after the K sample defect images are selected each time, to update the first sampled image set.

For ease of understanding, the second training image set formed by full new data of a task at a moment t+1 can be represented by Dₜ₊₁, and the first training image set formed by full historical training data at the moment t can be represented by D_{1:t}. In the related example, a full-data model is a new model obtained by using Dₜ₊₁+D_{1:t} as training data, and has good performance but high training cost. A common fine-tuning model is a model trained by using Dₜ₊₁, has low training cost but poorest performance, and may have catastrophic forgetting for old training data. In an aspect of the disclosure, to enable addition of a small amount of historical training data in an iteration process of new data to further reduce training cost and achieve training effect basically equivalent to that of using full data, a dynamic balancing sampling policy is employed for the old training data. In an example, in each training epoch, this method may stochastically sample p % of sample defect data from the first training image set and sample defect data from the second training image set to form the training data for the current epoch. Subsequently, in each iteration, the first sampled image set is sampled from the sample defect data in the first training image set. From the first sampled image set and the second training image set, historical sample defect images and newly added sample defect images are sampled at a ratio of 1:1 to constitute a batch for updating the model parameters. Stochastic sampling in each epoch ensures that the historical sample defect images used for each training undergo a dynamic variation process, so that capabilities or knowledge previously learned by the model from previous task data are maintained as much as possible after the complete task training is completed (e.g., requiring dozens of epochs). The balanced sampling in a ratio of 1:1 in each batch is conducive to further improving model performance, and preventing the model from having excellent performance only on a new task or only on an old task. A ratio of the historical sample defect image to the new sample defect image in each batch is further changed to 1:2 or 2:1, but the effect is far less than that of balanced sampling in the ratio of 1:1. Because batch data of a full-data model is stochastically formed by historical data and incremental data, a ratio of the historical data to the incremental data in one batch is approximate to an overall data ratio of the batch. The incremental data may be far less than the historical data, thereby impeding performance of a model trained in this way on a new task to some extent. On the contrary, a related fine-tuned model exclusively uses new data, and the model shifts towards the new data, leading to catastrophic forgetting for old tasks. This method uses a simple manner to effectively avoid problems caused by using full-data training and common model fine tuning, and greatly reduce training cost.

The method provided in an aspect of the disclosure may greatly accelerate a model iterative update process, and further maintains an effect equivalent to that of a full-data model. As service data accumulates, time for training the full-data model continues to increase, sometimes taking several days to complete single training. In an incremental training mode provided in this method, the training time can be maintained at a relatively low level, thereby greatly reducing GPU computational resource consumption. This is because the proposed method stochastically selects some historical data for training in each epoch, to ensure the dynamic variation of the historical data involved in training. During each batch of training, a 1:1 ratio of old data to new data is maintained, and a dynamic weight constraint method is employed to restrict changes of parameters that are critical for old tasks, so that the model does not suffer from catastrophic forgetting even when using only a small amount of historical data, meets project requirements, and significantly reduces iteration cost.

In an aspect of the model training method provided by FIG. 2 of the disclosure, referring to FIG. 9, before operation S120, sub-operation S111 to sub-operation S112 are further included. Details are as follows:

At S111, a sampling ratio of the first training image set is acquired.

At S112, sampling is performed on sample defect images in the first training image set based on a sampling ratio, to obtain a first sampled image set.

The sampling ratio of the first training image set is a preset sampling ratio, and aims at selecting a portion of sample defect images from the first training image set for a subsequent training process of the initial detection model. The sampling ratio of the first training image set is acquired, and the sample defect images in the first training image set are sampled based on the ratio. A sampling objective is to reduce a scale of training data and reserve important information.

In the method provided in an aspect of the disclosure, the sample defect images from the first sampled image set sampled from the first training image set serve as training samples of the initial detection model together with the sample defect images from the second training image set for further training the initial detection model. Compared to training with the full first training image set and second training image set, more time for training the initial model is reduced, and GPU computational resource consumption is reduced.

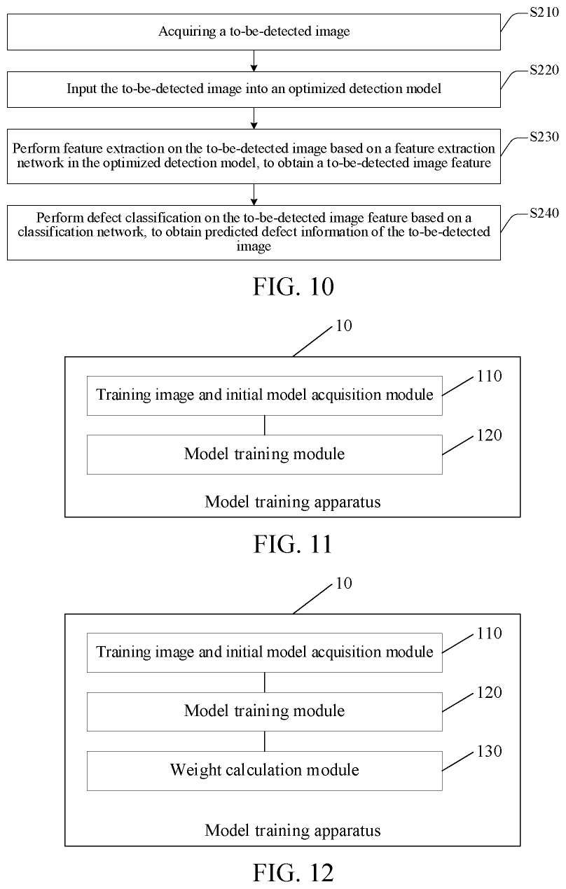

The following describes a defect detection method in the disclosure from a perspective of a server. Referring to FIG. 10, a defect detection method provided in an aspect of the disclosure includes operation S210 to operation S240. Details are as follows:

At S210, a to-be-detected image is acquired.

The to-be-detected image on which defect detection needs to be performed is acquired.

At S220, the to-be-detected image is input into an optimized detection model.

The optimized detection model includes a feature extraction network and a classification network, and the optimized detection model is obtained by using the foregoing model training method.

The acquired to-be-detected image is inputted into the optimized detection model. The optimized detection model is obtained by using the foregoing model training method, and includes a feature extraction network and a classification network. The feature extraction network is configured to perform feature extraction on an inputted image, and the classification network is configured to perform defect classification on extracted image features.

At S230, feature extraction is performed on the to-be-detected image based on the feature extraction network in the optimized detection model, to obtain a to-be-detected image feature.

The feature extraction network in the optimized detection model processes the to-be-detected image, to extract key features in the image. These features may be information such as a color, a shape, and texture of the image, and the features can represent defect features in the image.

At S240, defect classification is performed on the to-be-detected image feature based on the classification network, to obtain predicted defect information of the to-be-detected image.

The predicted defect information is configured for representing a classification result of whether the to-be-detected image includes a defect.

The classification network performs defect classification based on the extracted to-be-detected image feature and outputs the predicted defect information. The predicted defect information is configured for representing whether the to-be-detected image includes a defect and a class of the defect.

In the method provided in an aspect of the disclosure, the to-be-detected image is inputted into the optimized detection model, and processed and analyzed by using the feature extraction network and the classification network in the model, to finally obtain the predicted defect information of the to-be-detected image. The trained optimized detection model is employed to quickly and automatically perform defect detection on the to-be-detected image, to improve detection efficiency and accuracy. Moreover, the optimized detection model may adapt to different categories of defects and images through continuous training and updating, thereby improving a generalization capability of the model.

The following describes a model training apparatus in the disclosure in detail, referring to FIG. 11. FIG. 11 is an example of a schematic diagram of a model training apparatus 10 according to an aspect of the disclosure. The model training apparatus 10 includes a training image and initial model acquisition module 110 and a model training module 120. Details are as follows:

The training image and initial model acquisition module 110 is configured to acquire a first training image set, a second training image set, and an initial detection model, where the initial detection model is trained based on the first training image set, the first training image set includes a first sample defect image, the second training image set includes a second sample defect image, the second sample defect image is different from the first sample defect image, the initial detection model includes a first weight parameter set, the first weight parameter set includes a first weight parameter of a plurality of model parameters in the initial detection model, and the first weight parameter is configured for representing importance of the plurality of model parameters of the initial detection model.

The model training module 120 is configured to train the initial detection model based on a first sampled image set, the second training image set, and the first weight parameter, to adjust the plurality of model parameters of the initial detection model, to obtain a trained optimized detection model, where the first sampled image set includes a portion of first sample defect images in the first training image set, and the first weight parameter set is configured for constraining an adjustment magnitude of the model parameters in the initial detection model.

In the model training apparatus provided in an aspect of the disclosure, the initial detection model is trained by using some trained first training image sets and the full newly added second training image set, which saves more time and reduces GPU computational resource consumption compared to training the initial detection model by using full historical training data and the full newly added training data. By adaptively evaluating a first weight corresponding to the model parameter, updating of the model parameters by using historical training data is constrained, so that a problem of catastrophic forgetting caused by fine tuning the model by using only full newly added training data is solved, a learning capability of the model is improved, and the defect identification effect and accuracy of the model are enhanced.

In another implementation of an aspect of the disclosure, the model training module 120 is further configured to: acquire model parameters of a base detection model, the initial detection model being obtained by adjusting the model parameters of the base detection model; construct an objective function of the initial detection model based on a first weight parameter, model parameters of the initial detection model, the model parameters of the base detection model, a first sampled image set, and a second training image set; and train the initial detection model based on the objective function of the initial detection model, to adjust the model parameters of the initial detection model.

In the apparatus provided in an aspect of the disclosure, the initial detection model is adjusted and optimized more finely by using the objective function. Calculating the objective function provides quantitative evaluation on performance of the model on a data set, such as a predefined data set. This process may help us to find a better model configuration and improve accuracy and reliability of the model. In a practical application, an appropriate objective function and weight calculation apparatus needs to be selected based on a specific problem and data characteristics. In addition, a plurality of experiments and verifications further need to be performed to find an optimal parameter setting and model structure. Fine adjustment and optimization of these operations are to enable the model to better adapt to changes and requirements of data during practical application, and improve the performance and generalization capability of the model.

In another implementation of an aspect of the disclosure, the model training module 120 is further configured to: generate an incremental-data objective function of the initial detection model as a first optimization term based on the first sampled image set and the second training image set; and calculate a parameter difference between model parameters of the initial detection model and model parameters of the base detection model; generate a second optimization term based on the first weight parameter, the parameter difference, and a hyperparameter, the second optimization term being configured for constraining an adjustment magnitude of an important parameter during training, the important parameter being identified by using the first weight parameter, and the hyperparameter being configured to identify an impact degree of the second optimization term when training the initial detection model; and construct an objective function of the initial detection model based on the first optimization term and the second optimization term.

In the apparatus provided in an aspect of the disclosure, the objective function of the initial detection model is calculated by processing the sampled data, comparing the model parameters, and using weights The objective function may be used as an index for evaluating model performance, help us to know performance of the model on a data set, and instruct further optimization and improvement. This calculation process may help us to evaluate and improve the detection model more accurately, to improve the performance and accuracy of the detection model.

In another implementation of an aspect of the disclosure, the model training module 120 is further configured to: acquire a clipping threshold, the clipping threshold being configured for representing a gradient threshold when parameters of the initial detection model are updated, to constrain a gradient range when the parameters of the initial detection model are updated; and construct an objective function of the initial detection model based on the clipping threshold, the first weight parameter, the model parameters of the initial detection model, the model parameters of the base detection model, the first sampled image set, and the second training image set.

In another implementation of an aspect of the disclosure, the model training module 120 is further configured to: calculate a square root of the first weight parameter, calculate a parameter difference between the model parameters of the initial detection model and the model parameters of the base detection model, and multiply the square root of the first weight parameter by the parameter difference, to obtain a first calculation value; calculate, if the first calculation value is less than or equal to the clipping threshold, an objective function of the initial detection model based on the first weight parameter, the model parameters of the initial detection model, the model parameters of the base detection model, the first sampled image set, and the second training image set; and calculate, if the first calculation value is greater than the clipping threshold, the objective function of the initial detection model based on the clipping threshold, the first weight parameter, the model parameters of the initial detection model, the model parameters of the base detection model, the first sampled image set, and the second training image set.

In the apparatus provided in an aspect of the disclosure, the optimized detection model is adjusted and optimized more finely by calculating the objective function. Calculating the objective function provides quantitative evaluation on performance of the model on a data set. This process may help us to find a better model configuration and improve accuracy and reliability of the model. In a practical application, an appropriate objective function and weight calculation apparatus needs to be selected based on a specific problem and data characteristics. In addition, a plurality of experiments and verifications further need to be performed to find an optimal parameter setting and model structure. Fine adjustment and optimization of these operations are to enable the model to better adapt to changes and requirements of data during practical application, and improve the performance and generalization capability of the model.

In another implementation of an aspect of the disclosure, referring to FIG. 12, a model training apparatus 10 further includes a weight calculation module 130. In an example, the weight calculating module 130 is configured to: calculate a second weight parameter set of the optimized detection model based on the objective function of the initial detection model and the first weight parameter set, the second weight parameter set including a second weight parameter of a plurality of model parameters in the optimized detection model, the second weight parameter being configured for representing importance of the model parameters of the optimized detection model, and the second weight parameter set being configured for constraining an adjustment magnitude of the model parameters in the optimized detection model.

In the apparatus provided in an aspect of the disclosure, the optimized detection model is adjusted and optimized more finely by determining a second weight. The second weight is calculated to adjust parameter importance of the model based on an evaluation result. This process may help us to find a better model configuration and improve accuracy and reliability of the model. In a practical application, an appropriate objective function and weight calculation apparatus needs to be selected based on a specific problem and data characteristics. In addition, a plurality of experiments and verifications further need to be performed to find an optimal parameter setting and model structure. Fine adjustment and optimization of these operations are to enable the model to better adapt to changes and requirements of data during practical application, and improve the performance and generalization capability of the model.

In another implementation of an aspect of the disclosure, referring to FIG. 12, the weight calculation module 130 is further configured to: perform loss calculation on the objective function of the initial detection model for a plurality of times, to obtain a plurality of third weight parameter sets, the loss calculation being performed by performing derivative calculation on the objective function of the initial detection model, the third weight parameter set including a plurality of third weight parameters, the third weight parameters being configured for representing importance of the model parameters of the initial detection model for correctly identifying the second training image set; and add the plurality of third weight parameter sets to the first weight parameter set, to obtain the second weight parameter set corresponding to the optimized detection model.

In the apparatus provided in an aspect of the disclosure, importance of the model parameters of the optimized detection model are more accurately evaluated. This is conducive to improving performance and generalization capability of the model.

In another implementation of an aspect of the disclosure, referring to FIG. 11, the model training module 120 is further configured to: acquire a quantity of images corresponding to a training batch when the initial detection model is trained, the quantity of images being N, and N being an integer greater than 1; select K first sample defect images from the first sampled image set, and select L second sample defect images from the second training image set, K and L being integers greater than or equal to 1, and K+L=N; perform iterative training on the initial detection model based on the K first sample defect images in the first sampled image set, the L second sample defect images in the second training image set, and the first weight parameter; and delete the K first sample defect images from the first sampled image set, to obtain an updated first sampled image set, the updated first sampled image set being used as a sample set of the K first sample defect images during the iterative training.

The apparatus provided in an aspect of the disclosure may greatly accelerate a model iterative update process (reduce cost), and further maintain an effect equivalent to that of a full-data model. As service data accumulates, time for training the full-data model continues to increase, sometimes taking several days to complete single training. In an incremental training mode provided in this apparatus, the training time can be maintained at a relatively low level, thereby greatly reducing the GPU computational resource consumption. This is because the proposed apparatus stochastically selects some historical data for training in each epoch, to ensure the dynamic variation of the historical data involved in training. During each batch of training, a 1:1 ratio of old data to new data is maintained, and a dynamic weight constraint apparatus is employed to restrict changes of parameters that are critical for old tasks, so that the model does not suffer from catastrophic forgetting even when using a small amount of historical data, meets project requirements, and significantly reduces iteration cost.

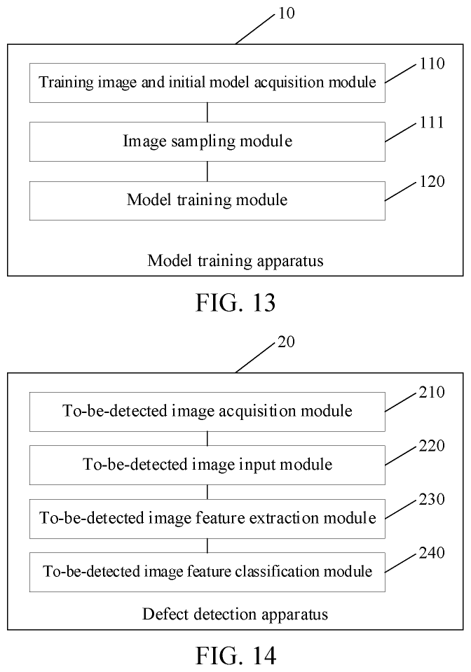

In another implementation of an aspect of the disclosure, referring to FIG. 13, the model training apparatus 10 further includes an image sampling module 111. In an example, the image sampling module 111 is configured to: acquire a sampling ratio of a first training image set; and perform sampling on sample defect images in the first training image set based on the sampling ratio, to obtain a first sampled image set.

In the apparatus provided in an aspect of the disclosure, the sample defect images from the first sampled image set sampled the first training image set serve as training samples of the initial detection model together with the sample defect images from the second training image set for further training the initial detection model. Compared to training with the full first training image set and second training image set, more time for training the initial model is reduced, and GPU computational resource consumption is reduced.

The following describes a defect detection apparatus in the disclosure in detail, referring to FIG. 14. FIG. 14 is an example of a schematic diagram of a defect detection apparatus 20 according to an aspect of the disclosure. The defect detection apparatus 20 includes: a to-be-detected image acquisition module 210, a to-be-detected image input module 220, a to-be-detected image feature extraction module 230, and a to-be-detected image feature classification module 240. Details are as follows:

The to-be-detected image acquisition module 210 is configured to acquire a to-be-detected image.

The to-be-detected image input module 220 is configured to input the to-be-detected image into an optimized detection model, where the optimized detection model includes a feature extraction network and a classification network, and the optimized detection model is obtained by using the foregoing model training apparatus.

The to-be-detected image feature extraction module 230 is configured to perform feature extraction on the to-be-detected image based on the feature extraction network in the optimized detection model, to obtain a to-be-detected image feature.

The to-be-detected image feature classification module 240 is configured to perform defect classification on the to-be-detected image feature based on the classification network, to obtain predicted defect information of the to-be-detected image, where the predicted defect information is configured for representing a classification result of whether the to-be-detected image includes a defect.

In the apparatus provided in an aspect of the disclosure, the to-be-detected image is inputted into the optimized detection model, and processed and analyzed by using the feature extraction network and the classification network in the model, to finally obtain the predicted defect information of the to-be-detected image. The trained optimized detection model is employed to quickly and automatically perform defect detection on the to-be-detected image, to improve detection efficiency and accuracy. Moreover, the optimized detection model may adapt to different categories of defects and images through continuous training and updating, thereby improving a generalization capability of the model.

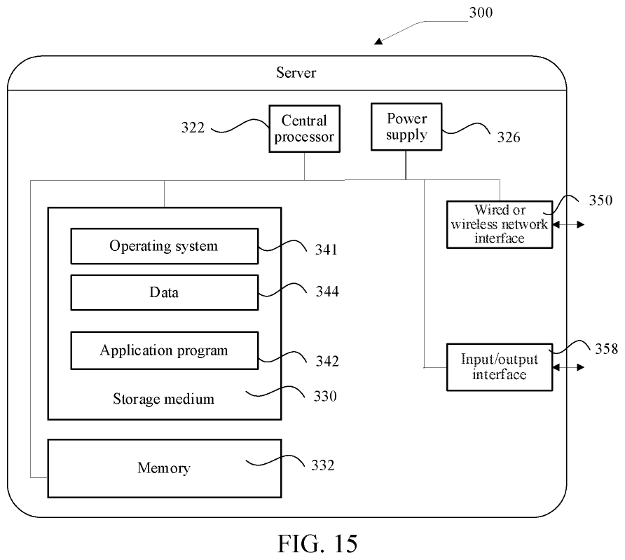

FIG. 15 is a schematic structural diagram of a server according to an aspect of the disclosure. The server 300 may vary greatly due to different configurations or performance, and may include one or more central processing units (CPUs) 322 (for example, one or more processors) and a memory 332, and one or more storage media 330 (for example, one or more mass storage devices) that store an application program 342 or data 344. The memory 332 and the storage medium 330 can be transient storage or persistent storage. The program stored in the storage medium 330 may include one or more modules (that are not shown in the figure), and each module may include a series of instruction operations on the server. Further, the central processing unit 322 may be configured to communicate with the storage medium 330, and execute, on the server 300, the series of instruction operations in the storage medium 330.

The server 300 may further include one or more power supplies 326, one or more wired or wireless network interfaces 350, one or more input/output interfaces 358, and/or one or more operating systems 341, such as Windows Server™, Mac OS X™, Unix™, Linux™, and FreeBSD™.

Operations performed by the server in the foregoing aspects may be based on the structure of the server shown in FIG. 15.

In addition, an aspect of the disclosure further provides a storage medium, where the storage medium is configured to store a computer program, and the computer program is configured for performing the method provided in the foregoing aspects.

An aspect of the disclosure further provides a computer program product including a computer program, and the computer program product, when run on a computer, causing the computer to perform the method provided in the foregoing aspects.

A person skilled in the art can understand that for convenience and conciseness of description, for specific working processes of the foregoing systems, devices, and units, reference may be made to the corresponding processes in the foregoing method aspects, and details are not described herein again.

In several aspects provided in the disclosure, the disclosed system, apparatus, and method may be implemented in other manners. For example, the apparatus aspects described above are merely illustrative. For example, the division of the units is only a logical function division, and there may be other divisions in actual implementation, for example, multiple units or components may be combined or integrated into another system, or some features may be ignored or not implemented. In addition, the displayed or discussed mutual coupling or direct coupling or communication connection may be indirect coupling or communication connection through interfaces, apparatuses or units, and may be in electrical, mechanical or other forms.

The units described as separate parts may or may not be physically separated, and components displayed as units may or may not be physical units, namely, may be located in one position, or may be distributed on a plurality of network units. Some or all of the units may be selected according to actual needs to achieve the objectives of the solutions of the aspects.

In addition, functional units in the aspects of the disclosure may be integrated into one processing unit, or each of the units may be physically separated, or two or more units may be integrated into one unit. The integrated unit may be implemented in the form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the disclosure essentially, or the part contributing to the related technology, or all or some of the technical solutions may be implemented in a form of a software product. The computer software product is stored in a storage medium and includes several instructions for instructing a computer device (that may be a personal computer, a server, a network device, or the like) to perform all or some of the operations of the methods described in the aspects of the disclosure. The foregoing storage medium includes: any medium that can store program code, such as a USB flash drive, a removable hard disk, a read-only memory (ROM), a random access memory (RAM), a magnetic disk, or an optical disc.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of defect detection, the method comprising:
acquiring a first training image set, a second training image set, and an initial detection model, the initial detection model being trained based on the first training image set, the first training image set including one or more first sample defect images, the second training image set including one or more second sample defect images, the one or more second sample defect images being different from the one or more first sample defect images, the initial detection model including a first weight parameter set, the first weight parameter set including a plurality of first weight parameters of a plurality of first model parameters in the initial detection model, and the plurality of first weight parameters indicating importance levels of the plurality of first model parameters in the initial detection model; and
training the initial detection model, based on a first sampled image set, the second training image set, and the first weight parameter set, to adjust the plurality of first model parameters of the initial detection model and to obtain an optimized detection model for defect detection, the first sampled image set including a subset of the one or more first sample defect images in the first training image set, and the optimized detection model being obtained from the training of the initial detection model with adjustment magnitudes of the plurality of first model parameters in the initial detection model being constrained according to the importance levels that are indicated by the plurality of first weight parameters.

2. The method according to claim 1, wherein the training comprises:
acquiring base model parameters of a base detection model, the initial detection model being obtained by adjusting the base model parameters of the base detection model;
constructing an objective function of the initial detection model based on the plurality of first weight parameters, the plurality of first model parameters of the initial detection model, the base model parameters of the base detection model, the first sampled image set, and the second training image set; and
training the initial detection model based on the objective function of the initial detection model, to adjust the plurality of first model parameters in the initial detection model.

3. The method according to claim 2, wherein the constructing comprises:
generating an incremental-data objective function of the initial detection model as a first optimization term based on the first sampled image set and the second training image set;
calculating parameter differences between the plurality of first model parameters of the initial detection model and the base model parameters of the base detection model;
generating a second optimization term based on the plurality of first weight parameters, the parameter differences, and a hyperparameter, the second optimization term indicating constraining of an adjustment magnitude of an important parameter during training, the important parameter being identified by using the plurality of first weight parameters, and the hyperparameter identifying an impact degree of the second optimization term when the initial detection model is trained; and
constructing the objective function of the initial detection model based on the first optimization term and the second optimization term.

4. The method according to claim 2, wherein the constructing comprises:
acquiring a clipping threshold, the clipping threshold being a gradient threshold and configured to, when parameters of the initial detection model are updated, constrain a gradient range when the plurality of first model parameters of the initial detection model are updated; and
constructing the objective function of the initial detection model based on the clipping threshold, the plurality of first weight parameters, the plurality of first model parameters of the initial detection model, the base model parameters of the base detection model, the first sampled image set, and the second training image set.

5. The method according to claim 4, wherein the constructing comprises:
calculating a square root of a first weight parameter of the plurality of first weight parameters;
calculating a parameter difference between a first model parameter in the plurality of first model parameters of the initial detection model and a first base model parameter in the base model parameters in the base detection model that corresponds to the first model parameter of the plurality of first model parameters in the initial detection model;
multiplying the square root by the parameter difference, to obtain a first calculation value;
calculating, when the first calculation value is less than or equal to the clipping threshold, the objective function of the initial detection model based on the plurality of first weight parameters, the plurality of first model parameters of the initial detection model, the base model parameters of the base detection model, the first sampled image set, and the second training image set; and
calculating, when the first calculation value is greater than the clipping threshold, the objective function of the initial detection model based on the clipping threshold, the plurality of first weight parameters, the plurality of first model parameters of the initial detection model, the base model parameters of the base detection model, the first sampled image set, and the second training image set.

6. The method according to claim 1, the method further comprising:
calculating a second weight parameter set for the optimized detection model based on an objective function of the initial detection model and the first weight parameter set, the optimized detection model including a plurality of second model parameters, the second weight parameter set including a plurality of second weight parameters for the plurality of second model parameters in the optimized detection model, the plurality of second weight parameters indicating respective importance levels of the plurality of second model parameters of the optimized detection model.

7. The method according to claim 6, wherein the calculating comprises:
performing a plurality of loss calculations on the objective function of the initial detection model, to obtain a plurality of third weight parameter sets, each of the plurality of loss calculations being configured to perform a respective derivative calculation on the objective function of the initial detection model, each of the plurality of third weight parameter sets including a plurality of third weight parameters that indicates respective importance levels of the plurality of first model parameters of the initial detection model for correctly identifying the second training image set; and
adding the plurality of third weight parameter sets with the first weight parameter set, to obtain the second weight parameter set for the optimized detection model.

8. The method according to claim 1, wherein the training the initial detection model comprises:
acquiring a quantity of images for a training batch when the initial detection model is trained, the quantity of images being N, and N being an integer greater than 1;
selecting K first sample defect images from the first sampled image set, K being an integer greater than or equal to 1;
selecting L second sample defect images from the second training image set, L being integers greater than or equal to 1, and K+L=N; and
performing a first round of an iterative training on the initial detection model based on the K first sample defect images in the first sampled image set, the L second sample defect images in the second training image set, and the plurality of first weight parameters.

9. The method according to claim 8, the method further comprising:
deleting the K first sample defect images from the first sampled image set, to obtain an updated first sampled image set, the updated first sampled image set being used as a sample set to select K first sample defect images for a second round of the iterative training.

10. The method according to claim 1, before the initial detection model is trained, further comprising:
acquiring a sampling ratio of the first training image set; and
performing sampling on sample defect images in the first training image set based on the sampling ratio, to obtain the first sampled image set.

11. The method according to claim 1, further comprising:
acquiring a to-be-detected image;
inputting the to-be-detected image into the optimized detection model, the optimized detection model including a feature extraction network and a classification network;
performing feature extraction on the to-be-detected image based on the feature extraction network in the optimized detection model, to obtain a to-be-detected image feature; and
performing defect classification on the to-be-detected image feature based on the classification network, to obtain predicted defect information of the to-be-detected image, the predicted defect information indicating whether the to-be-detected image includes a defect.

12. A defect detection apparatus, comprising:
processing circuitry configured to:
acquire a first training image set, a second training image set, and an initial detection model, the initial detection model being trained based on the first training image set, the first training image set including one or more first sample defect images, the second training image set including one or more second sample defect images, the one or more second sample defect images being different from the one or more first sample defect images, the initial detection model including a first weight parameter set, the first weight parameter set including a plurality of first weight parameters of a plurality of first model parameters in the initial detection model, and the plurality of first weight parameters indicating importance levels of the plurality of first model parameters in the initial detection model; and
train the initial detection model, based on a first sampled image set, the second training image set, and the first weight parameter set, to adjust the plurality of first model parameters of the initial detection model and to obtain an optimized detection model for defect detection, the first sampled image set including a subset of the one or more first sample defect images in the first training image set, and the optimized detection model being obtained from the training the initial detection model with adjustment magnitudes of the plurality of first model parameters in the initial detection model being constrained according to the importance levels that are indicated by the plurality of first weight parameters.

13. The defect detection apparatus of claim 12, wherein the processing circuitry is configured to:
acquire base model parameters of a base detection model, the initial detection model being obtained by adjusting the base model parameters of the base detection model;
construct an objective function of the initial detection model based on the plurality of first weight parameters, the plurality of first model parameters of the initial detection model, the base model parameters of the base detection model, the first sampled image set, and the second training image set; and
train the initial detection model based on the objective function of the initial detection model, to adjust the plurality of first model parameters in the initial detection model.

14. The defect detection apparatus of claim 13, wherein the processing circuitry is configured to:
generate an incremental-data objective function of the initial detection model as a first optimization term based on the first sampled image set and the second training image set;
calculate parameter differences between the plurality of first model parameters of the initial detection model and the base model parameters of the base detection model;
generate a second optimization term based on the plurality of first weight parameters, the parameter differences, and a hyperparameter, the second optimization term indicating constraining of an adjustment magnitude of an important parameter during training, the important parameter being identified by using the plurality of first weight parameters, and the hyperparameter identifying an impact degree of the second optimization term when the initial detection model is trained; and
construct the objective function of the initial detection model based on the first optimization term and the second optimization term.

15. The defect detection apparatus of claim 13, wherein the processing circuitry is configured to:
acquire a clipping threshold, the clipping threshold being a gradient threshold and configured to, when parameters of the initial detection model are updated, constrain a gradient range when the plurality of first model parameters of the initial detection model are updated; and
construct the objective function of the initial detection model based on the clipping threshold, the plurality of first weight parameters, the plurality of first model parameters of the initial detection model, the base model parameters of the base detection model, the first sampled image set, and the second training image set.

16. The defect detection apparatus of claim 15, wherein the processing circuitry is configured to:
calculate a square root of a first weight parameter of the plurality of first weight parameters;
calculate a parameter difference between a first model parameter in the plurality of first model parameters of the initial detection model and a first base model parameter in the base model parameters in the base detection model that corresponds to the first model parameter of the plurality of first model parameters in the initial detection model;
multiply the square root by the parameter difference, to obtain a first calculation value;
calculate, when the first calculation value is less than or equal to the clipping threshold, the objective function of the initial detection model based on the plurality of first weight parameters, the plurality of first model parameters of the initial detection model, the base model parameters of the base detection model, the first sampled image set, and the second training image set; and
calculate, when the first calculation value is greater than the clipping threshold, the objective function of the initial detection model based on the clipping threshold, the plurality of first weight parameters, the plurality of first model parameters of the initial detection model, the base model parameters of the base detection model, the first sampled image set, and the second training image set.

17. The defect detection apparatus of claim 12, wherein the processing circuitry is configured to:
calculate a second weight parameter set for the optimized detection model based on an objective function of the initial detection model and the first weight parameter set, the optimized detection model including a plurality of second model parameters, the second weight parameter set including a plurality of second weight parameters for the plurality of second model parameters in the optimized detection model, the plurality of second weight parameters indicating respective importance levels of the plurality of second model parameters of the optimized detection model.

18. The defect detection apparatus of claim 17, wherein the processing circuitry is configured to:
perform a plurality of loss calculations on the objective function of the initial detection model, to obtain a plurality of third weight parameter sets, each of the plurality of loss calculations being configured to perform a respective derivative calculation on the objective function of the initial detection model, each of the plurality of third weight parameter sets including a plurality of third weight parameters that indicates respective importance levels of the plurality of first model parameters of the initial detection model for correctly identifying the second training image set; and
add the plurality of third weight parameter sets with the first weight parameter set, to obtain the second weight parameter set for the optimized detection model.

19. The defect detection apparatus of claim 12, wherein the processing circuitry is configured to:
acquire a quantity of images for a training batch when the initial detection model is trained, the quantity of images being N, and N being an integer greater than 1;
select K first sample defect images from the first sampled image set, K being an integer greater than or equal to 1;
select L second sample defect images from the second training image set, L being integers greater than or equal to 1, and K+L=N; and
perform a first round of an iterative training on the initial detection model based on the K first sample defect images in the first sampled image set, the L second sample defect images in the second training image set, and the plurality of first weight parameters.

20. A non-transitory computer readable storage medium storing instructions which, when executed by at least one processor, cause the at least one processor to perform:
acquiring a first training image set, a second training image set, and an initial detection model, the initial detection model being trained based on the first training image set, the first training image set including one or more first sample defect images, the second training image set including one or more second sample defect images, the one or more second sample defect images being different from the one or more first sample defect images, the initial detection model including a first weight parameter set, the first weight parameter set including a plurality of first weight parameters of a plurality of first model parameters in the initial detection model, and the plurality of first weight parameters indicating importance levels of the plurality of first model parameters in the initial detection model; and
training the initial detection model, based on a first sampled image set, the second training image set, and the first weight parameter set, to adjust the plurality of first model parameters of the initial detection model and to obtain an optimized detection model for defect detection, the first sampled image set including a subset of the one or more first sample defect images in the first training image set, and the optimized detection model being obtained from the training of the initial detection model with adjustment magnitudes of the plurality of first model parameters in the initial detection model being constrained according to the importance levels that are indicated by the plurality of first weight parameters.
